(19) United States
(12) Patent Application Publication
(10) Pub. No.: US 2010/0033435 A1
(43) Pub. Date: Feb. 11, 2010

(54) USER INPUT ON ROLLABLE DISPLAY DEVICE

(75) Inventor: Hjalmar Edzer Ayco Huitema, Veldhoven (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Polymer Vision Limited, Eindhoven (NL)

(21) Appl. No.: 12/304,547

(22) PCT Filed: Jun. 14, 2007
(86) PCT No.: PCT/NL2007/050281

§ 371 Date: Sep. 28, 2009

Related U.S. Application Data
(60) Provisional application No. 60/804,677, filed on Jun. 14, 2006.

(51) Int. Cl. G06F 3/041; G06F 3/01

(52) U.S. Cl. 345/173; 345/156

(57) ABSTRACT

A rollable display device (30) is provided with horizontal and vertical selection and detection means for activating a (x-y) coordinate region within a viewing portion (i.e., display area) of the device without requiring direct contact with the display area. The horizontal region may be selected by simply rolling out the display to a desired horizontal position and detecting that position. In various embodiments, the vertical region may be detected by one of button selection means (38), slider control means and touch screen activation means.

This invention relates generally to inputting information in mobile devices. More particularly, the invention relates to input means for use in a mobile device that overcomes the need to incorporate touch screen activation methods and apparatus.

Users have become accustomed to the conveniences that mobile devices such as global positioning system (GPS) receivers, mobile telephones, personal digital assistants (PDAs), eBook readers, and laptops, have to offer. Technology has made it possible to outfit the present generation of such devices with rollable displays.

Despite the advantages, rollable displays presently do not include touch input options because of the potential damage that may occur. Conventional displays, by contrast, offer a number of standard solutions for incorporating touch activation capabilities. One method utilized in conventional displays is the use of an additional touch activation sheet that is placed in front of the display. This is not a feasible solution for a rollable display because the touch activation sheet typically contains two substrates which does not allow the display to remain rollable.

One solution for incorporating touch activation capabilities without utilizing a touch activation sheet is found in the InkLink™ by Seiko which employs acoustical and optical receivers for determining the exact location of a stylus by relying on a time difference between the reception of optical and acoustical pulses. This is not a feasible solution for a rollable display because the additional electronics and corresponding electrical, optical or acoustical field over the display increase the power consumption of the device.

Therefore a need exists to provide input means in a rollable display which overcomes the disadvantages discussed above.

The present invention addresses the above-noted and other deficiencies of the prior art by providing, in a mobile display device, horizontal and vertical selection means for selecting an area to be activated on a viewing portion of the display device. The area to be activated on the viewing portion is defined by an independently selectable horizontal and vertical input region (x-y coordinates) on the viewing portion of the mobile display device.

The horizontal and vertical selection means of the invention advantageously overcome the need for a user to select vertical and horizontal regions (x-y coordinates) via touch screen activation methods and apparatus, as described above. A further advantage of the invention is that a user is not required to make direct contact with the viewing portion of the device to select the vertical and horizontal regions (x-y coordinates) which minimizes potential damage to the viewing portion.

The vertical selection means for selecting a vertical input region (y-coordinate) may comprise, in various embodiments, button selection means, slider control means and touch screen activation means. The selected vertical input region is then detected by vertical detection means.

In one embodiment, the vertical selection means for selecting a vertical input region on the viewing portion comprises a slider control on a front surface of a housing of the device for selecting a vertical input point on a device display.

In one embodiment, the vertical selection means for selecting a vertical position on the viewing portion comprises a non-transparent touch-activation embedded in a housing of the device for selecting a vertical input point on a device display.

In one embodiment, the vertical selection means for selecting a vertical input region on the viewing portion comprises a transparent touch-activation area pivotally coupled to a housing of the device for selecting a vertical input point on a device display.

In one embodiment, the vertical selection means for selecting a vertical input region on the viewing portion comprises a plurality of buttons on a front surface of a housing of the device for selecting a vertical input point on a device display.

In one embodiment, the vertical selection means for selecting a vertical input region on the viewing portion comprises a transparent touch-activation area embedded in a housing of the device for selecting a vertical input point on a device display.

The horizontal selection means for selecting a horizontal input region (x-coordinate) preferably comprises a user rolling out the device in the horizontal direction to a desired horizontal position which is then detected by horizontal detection means.

In one embodiment, the horizontal detection means comprises measuring the resistance of a variable resistance element that is attached to a rolling mechanism which stores the viewing portion (i.e., display) and calculating the horizontal input position based on the measured resistance.

In one embodiment, the horizontal detection means comprises horizontal sensing means for sensing the number of turns of the rolling mechanism and calculation means for calculating the user selected rolled out horizontal position based on the number of turns.

According to one aspect of the present invention, a method for selecting a horizontal and a vertical input position on a mobile device display comprises:

It is noted that there is no restriction on the order in which a user selects the vertical and horizontal input regions for activating an area of the viewing portion. In accordance with a preferred mode of operation, both the user selected horizontal and vertical input regions are processed substantially simultaneously by the device. In this manner, device power and CPU cycles may be optimized.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

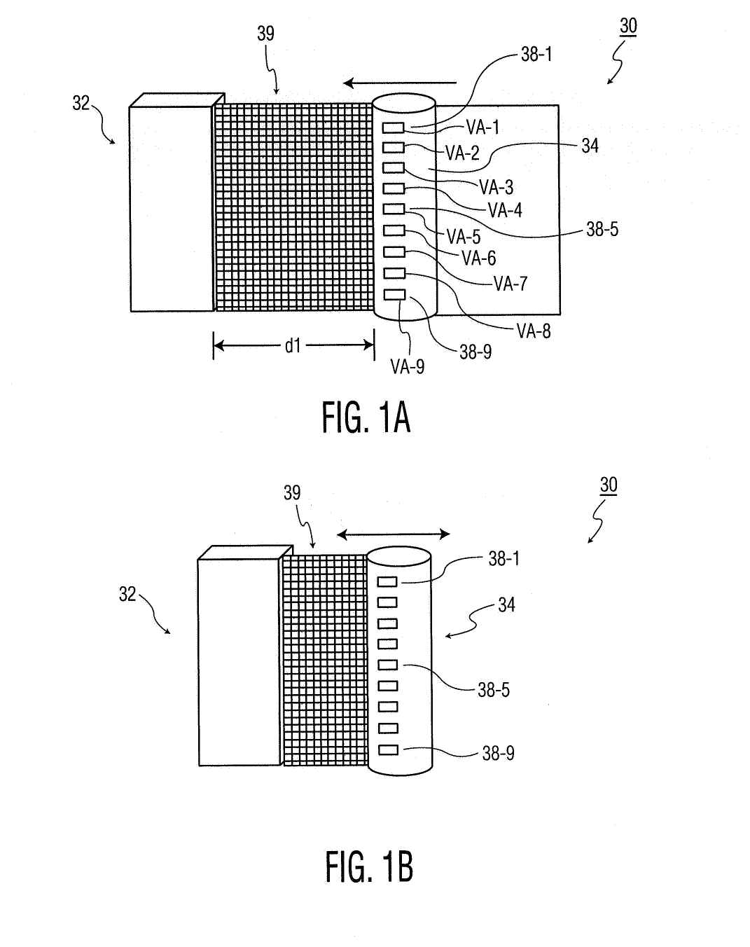

FIG. 1a is a view in the extended configuration of a rollable display device including a user interface on a second housing of the device, wherein the user interface comprises a plurality of buttons in accordance with one embodiment of the present invention;

FIG. 1b is a view of the rollable display device of FIG. 1a in a partially extended configuration, in accordance with one embodiment of the present invention;

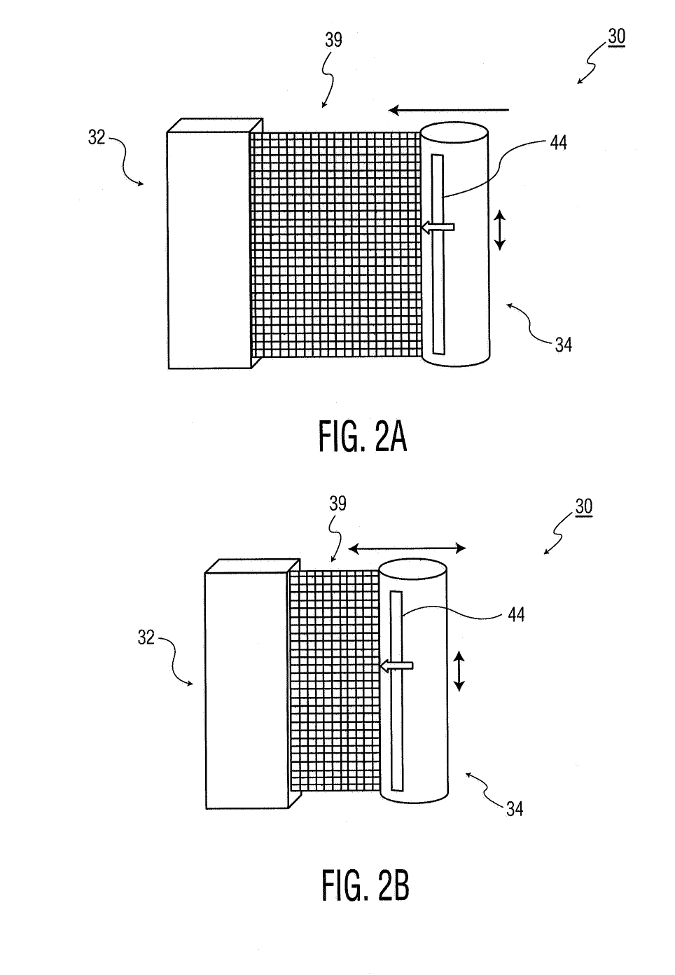

FIG. 2a is a view in a fully extended configuration of a rollable display device including a slider control for selecting a vertical input position, in accordance with one embodiment of the present invention;

FIG. 2b is a view of the rollable display device of FIG. 2a in a partially extended configuration, in accordance with one embodiment of the present invention;

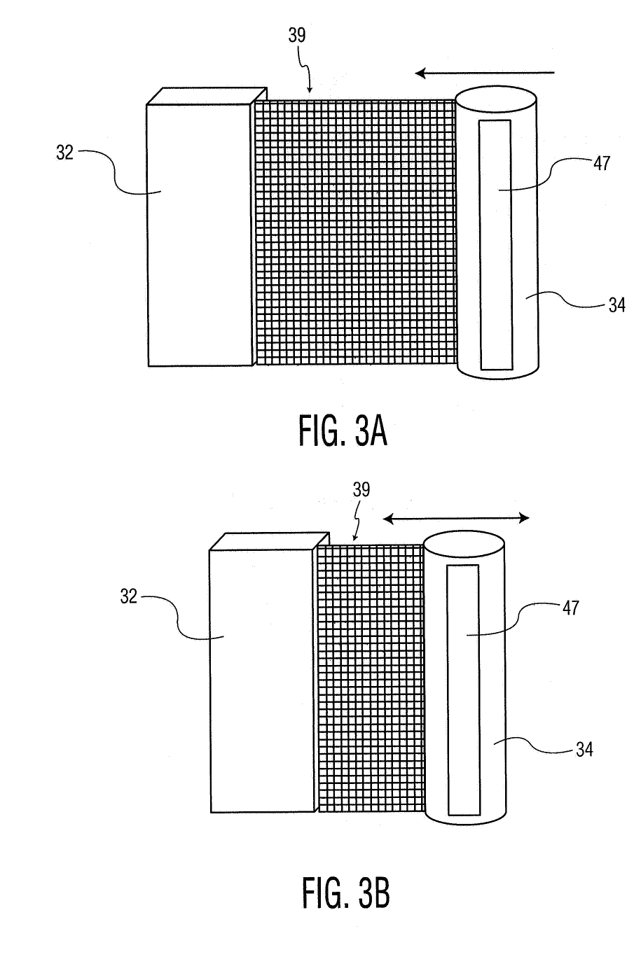

FIG. 3a is a view in a fully extended configuration of a rollable display device including a non-transparent user interface for selecting a vertical input position, in accordance with one embodiment of the present invention;

FIG. 3b is a view of the rollable display device of FIG. 3a in a partially extended configuration, in accordance with one embodiment of the present invention;

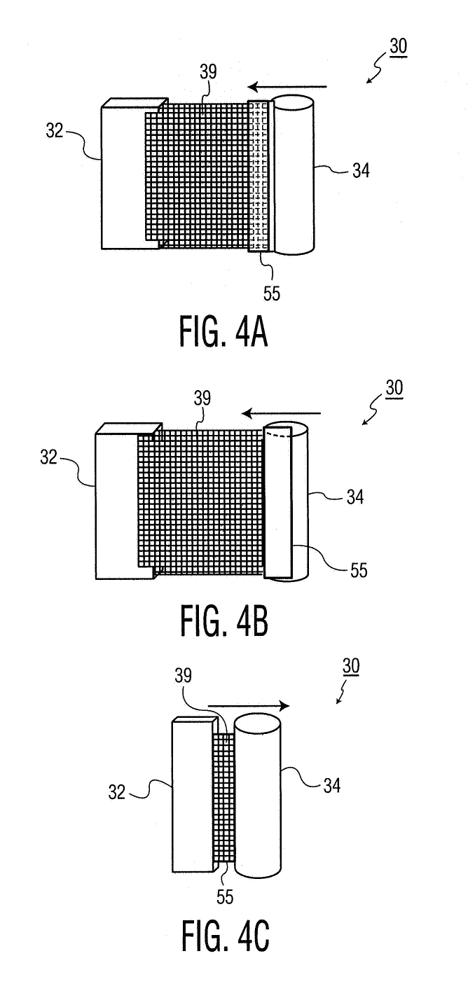

FIG. 4a is a view in the fully extended configuration of a rollable display device including a user interface on a second housing of the device comprising a pivotally coupled touch-active transparent area, in accordance with one embodiment of the present invention;

FIG. 4b is a view of the rollable display device of FIG. 4a, in the partially extended configuration

FIG. 4c is a view in the closed configuration of a rollable display device of FIG. 4a;

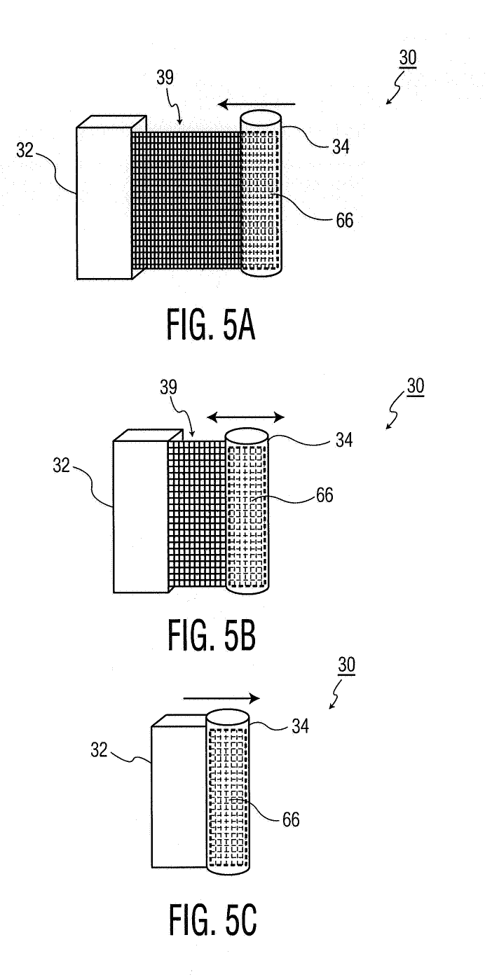

FIG. 5a is a view in the fully extended configuration of a rollable display device including a user interface on a second housing of the device comprising an integrated touch-active transparent area, in accordance with one embodiment of the present invention;

FIG. 5b is a view of the rollable display device of FIG. 5a, in the partially extended configuration; and

FIG. 5c is a view in the closed configuration of a rollable display device of FIG. 5a;

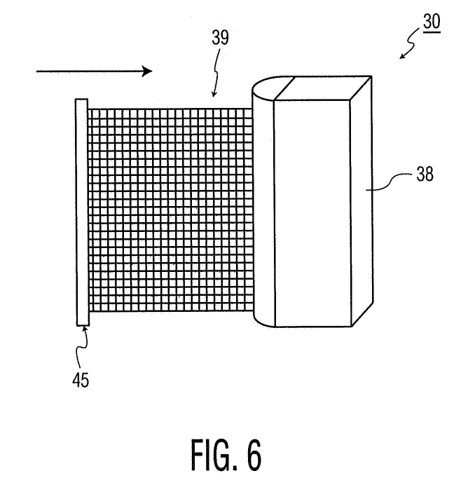

FIG. 6 is a view in a partially extended configuration of a rollable display device including a single housing, according to an embodiment of the invention.

Embodiments of the invention are discussed below with reference to FIGS. 1-6. However, those skilled in the art will readily appreciate that the detailed description given herein with respect to those figures is for explanatory purposes as the invention extends beyond these limited embodiments.

FIGS. 1-6, in which like elements share like reference numbers, are views of a mobile device including a user interface on a second housing of the device, in accordance with exemplary embodiments of the present invention.

While the described embodiments describe the device 30 shown in FIGS. 1-6 as rollable display device, the device can be any electronic device displaying information, such as a global positioning system (GPS) receiver, a mobile telephone, a personal digital assistant (PDA), an eBook reader, a laptop and the like.

While the described embodiment describe the display 39 as a viewing portion 39, the display can be any flexible, partially flexible, rollable or partially rollable display able to display graphical information, such as an electorphoretic display, electronic paper, OLED displays, polyLED displays, LC displays, electrowetting displays, rotating ball displays, direct drive displays, segmented displays, passive-matrix displays or active-matrix displays or the like.

In one embodiment shown in FIGS. 1a and 1b, a rollable display device 30 is shown in an extended (FIG. 1a) and a partially extended (FIG. 1b) configuration in which a viewing portion 39 of the rollable display device 30 is rolled out to display information to the user. As used herein, the terms “extended”, “partially extended”, “partially extended configuration” and “extended configuration” are defined as the configurations in which the first and second housings 32, 34 of the rollable display device 30 are fully or partially separated, as shown, and the viewing portion 39 is extended and visible to the user.

In accordance with the embodiments described herein, to select a horizontal input position or region on the viewing portion 39, a user rolls out the rollable display device 30 by extending the second housing 34 to a desired horizontal position (e.g., see “d1” in FIG. 1A). The horizontal input position is sensed by horizontal detection means.

In one embodiment, the horizontal detection means may comprise a meter, having a variable resistance that is attached to a rolling mechanism integrated into the second housing 34 of the rollable display device 30 for rolling up the viewing portion 39. The meter attached to the rolling mechanism makes instantaneous resistance measurements for determining the horizontal input position. A processor (not shown) in the device 30 computes the horizontal distance from the resistance measurement as one input. In one embodiment, the first housing 32 of the rollable display device 30 is a base housing that encloses electronic circuitry including the processor for performing, inter alia, the computing operations for determining the horizontal and vertical input positions.

In accordance with one embodiment, the horizontal detection means for detecting the horizontal position or region may be performed via optical detection means by optically sensing the number of rotations of the device 30 as it is rolled out to an extended or semi-extended horizontal position.

In yet another embodiment, the horizontal detection means for detecting the horizontal position or region may be performed via electronic detection means by electronically sensing the number of rotations of the device 30 as it is rolled out to an extended or semi-extended position. Optical and electronic sensing means for performing the described functions are well known in the art and will therefore not be further discussed.

In the embodiment illustrated in FIGS. 1a and 1b, the vertical selection means for selecting a vertical input position or region comprises a plurality of input buttons 38-1 to 38-9 positioned on a front surface of a second housing 34 of the rollable display device 30. The plurality of input buttons 38-1 to 38-9 are shown arranged in a linear configuration and configured to select various areas or regions of the viewing portion 39 in the vertical direction. For example, referring to FIG. 1a, button 38-1 selects vertical viewing area (VA-1) on the viewing portion 39. It should be appreciated that the number and configuration of input buttons 38-1 to 38-9 shown in FIGS. 1a and 1b constitutes an exemplary non-limiting configuration.

In operation, for the exemplary embodiment illustrated in FIGS. 1a and 1b, to select a particular vertical input area or region on the viewing portion 39 (VA-1 through VA-9), a user selects (depresses) one of the plurality of input buttons 38-1 to 38-9. Each input button 38-1 to 38-9 is configured to transmit identifying information to a processor (not shown) as an input to an internally stored device table associating the particular input button 38-1 to 38-9 with a specific vertical input area or region.

Table I. illustrates, by way of example, an internally stored device table corresponding to the exemplary device 30 shown in FIGS. 1a and 1b. Referring to row 1 of Table I, button identifier 38-1, when depressed, is configured to select vertical input area VA-1 (as shown in FIG. 1a). Of course, different quantities and arrangements of buttons may provide different degrees of selection granularity.

TABLE I

| Button Identifier | Vertical Input Area |
|---|---|
| 38-1 | VA-1 |
| 38-2 | VA-2 |
| 38-3 | VA-3 |
| 38-4 | VA-4 |
| 38-5 | VA-5 |
| 38-6 | VA-6 |
| 38-7 | VA-7 |
| 38-8 | VA-8 |
| 38-9 | VA-9 |

Another exemplary embodiment of a rollable display device 30 according to the present invention is illustrated in FIGS. 2a and 2b. This embodiment lacks the plurality of input buttons 38 as compared to the device shown in FIGS. 1a and 1b, respectively. Instead, this embodiment is equipped with a slider control 44 incorporated on a front surface of the second housing 34. The depicted slider control 44 allows a user to select a vertical input area or region on the viewing portion 39 of the device 30 by sliding the control 44 to a desired vertical screen position. The slider control 44 may provide a finer granularity than the plurality of input buttons 38, described above, for selecting a vertical input area or region on the viewing portion 39.

Another exemplary embodiment of a rollable display device 30 according to the present invention is illustrated in FIGS. 3a and 3b. This embodiment lacks the plurality of input buttons 38 as compared to the device in FIG. 1, respectively and the slider control 44 as compared to the device in FIG. 2. Instead, this embodiment is equipped with a non-transparent touch activation area 47 that is embedded within a front surface of the second housing 34. The non-transparent touch active activation area 47 serves as a vertical selection interface for a portion of the viewing portion 39 directly to the left of the touch activation area 47. By rolling the display in and out, it is possible to position all parts of the viewing portion 39 to the left of the touch activation area 47, as illustrated, by way of example in FIGS. 3a and 3b.

FIG. 3a schematically illustrates the device 30 in a completely extended (rolled out) configuration including the transparent touch activation area 47 shown embedded in the second housing 34.

FIG. 3b schematically illustrates the device 30 in a partially extended (rolled out) configuration including the transparent touch activation area 47.

In operation, horizontal and vertical input signals are generated by the device 30 in response to the user selecting a vertical input region or area via the touch activation area 47. That is, upon determining that a user has actively selected a vertical input area or region, a controller in the device 30 receives and processes a vertical input signal generated by the touch activation area and similarly processes a horizontal input signal generated by horizontal detection means, described above. The two signals are processed substantially simultaneously to activate a particular area of the viewing portion 39 defined by the combined user selected vertical and horizontal regions (i.e., x-y coordinates).

Another exemplary embodiment of a rollable display device 30 according to the present invention is illustrated in FIGS. 4a-4c. This embodiment is equipped with a transparent touch activation area 55 that is shown pivotally coupled to the second housing 34. The transparent touch active activation area 55 serves as a touch screen for a portion of the viewing portion 39 directly beneath the touch activation area 55. By rolling the display in and out, it is possible to position all parts of the viewing portion 39 beneath the touch activation area 55.

FIGS. 4a and 4b schematically illustrates the device 30 in a completely extended configuration including the transparent touch activation area 55 shown pivotally coupled to the second housing 38. FIG. 4a schematically illustrates transparent touch activation area 55 shown pivotally coupled to the second housing 38 and positioned directly over the right side of the viewing portion. FIG. 4b schematically illustrates transparent touch activation area 55 shown pivotally coupled to the second housing 38 and positioned directly over the second housing 34.

The pivotal coupling allows the touch screen activation area 55 to cover or uncover the right side of the viewing portion 39, as shown in FIGS. 4a and 4b, respectively.

FIG. 4c schematically illustrates the device 30 including the transparent touch activation area 55 in a completely rolled in configuration with the touch screen activation area 55 is shown covering the entire exposed portion of the viewing portion 39. In this configuration, it would be advantageous to eliminate the need for opening the device 30 for selecting vertical coordinates on a portion of the viewing portion 39 while the device 30 is in the closed position.

Another exemplary embodiment of a rollable display device 30 according to the present invention is schematically illustrated in FIGS. 5a-c. This embodiment is similar to the fourth embodiment described above, in that it incorporates a touch activation area 66 for selecting a vertical input on the viewing portion 39 that is beneath the transparent touch activation area 55. However, this embodiment differs from the immediately preceding embodiment in that the touch activation area 66 is not pivotally coupled to the second housing 34 as shown in FIGS. 4a-4c. Instead, in the presently described embodiment, the touch activation area 66 is integrated into the second housing 34 of the device 30 and is preferably made of a clear or transparent material which provides a more streamlined device 30. As shown in FIGS. 5a-c, an advantage provided by the present exemplary embodiment is that a subset of the viewing portion 39 is always visible, irrespective of the horizontal position of the second housing 34.

Another exemplary embodiment of a rollable display device 30 according to the present invention is schematically illustrated in FIG. 6. In this embodiment, a single housing 38 is shown from which the viewing portion 39 may be extracted or retracted (as shown) by utilizing a small bar 45 attached to the viewing portion 39 (on the left). It is appreciated that, in the present embodiment, the viewing portion 39 preferably includes supporting structure which keeps the viewing portion 39 flat and in position while in the extended or partially extended configurations

The present embodiment may utilize vertical input selection means (not shown) in accordance with those described hereinabove. Specifically, the single housing 38 of the present embodiment may utilize one of a plurality of input buttons, a slider control, a non-transparent touch activation area, a transparent touch activation area pivotally coupled to the single housing 38 or a transparent touch activation area embedded within the single housing 38.

Although this invention has been described with reference to particular embodiments, it will be appreciated that many variations will be resorted to without departing from the spirit and scope of this invention as set forth in the appended claims. The scope of the invention is indicated in the appended claims, and all changes that come within the meaning and range of equivalents are intended to be embraced therein. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A display device comprising:
a housing coupled at an end of the display device,
a viewing portion connected to said housing at an end,
horizontal selection means for selecting a horizontal region within said viewing portion without requiring direct contact with said viewing portion,
vertical selection means for selecting a vertical region within said viewing portion without requiring direct contact with said viewing portion,
horizontal detection means for detecting said selected horizontal region within said viewing portion, and for generating a first signal responsive to said horizontal detection,
vertical detection means for detecting said selected vertical region
within said viewing portion, and for generating a second signal responsive to said vertical detection, and
a controller for receiving said first and second signals and for substantially simultaneously activating said vertical and horizontal regions responsive to said first and second received signals.

2. The display device of claim 1, wherein said vertical and horizontal regions comprise an activated area of said viewing portion.

3. The display device of claim 1, wherein said controller activates said vertical and horizontal regions upon receiving said second signal.

4. The display device of claim 1, wherein the horizontal detection means comprises measurement means for measuring the resistance of a variable resistance element fixedly attached to a extending mechanism of the viewing portion, said measured resistance corresponding to a prescribed horizontal distance.

5. The display device of claim 1, wherein the horizontal detection means comprises optical detection means for detecting an optical signal transmitted from an optical transmitter fixedly attached to an extending mechanism of the viewing portion, said optical signal corresponding to a prescribed horizontal distance.

6. The display device of claim 1, wherein the horizontal detection means comprises electronic detection means for detecting an electronic signal transmitted from an electronic transmitter fixedly attached to a extending mechanism of the viewing portion, said electronic signal corresponding to a prescribed horizontal distance.

7. The display device of claim 1, wherein the vertical selection means comprises a plurality of keys located on a front surface of said housing, wherein each of said plurality of keys is configured to activate a particular vertical region of said viewing portion.

8. The display device of claim 1, wherein the vertical selection means comprises:
a sliding member operable to slide throughout a vertical dimension of the viewing portion to select a particular vertical region of said viewing portion, and
control logic operatively coupled to the sliding member for generating a signal corresponding to the position of the sliding member.

9. The display device of claim 1, wherein the vertical selection means comprises:
a touch-sensitive activation area pivotally coupled to the housing of the display device, the touch-sensitive activation area having defined thereon a plurality of segments designated as keys, and a plurality of sensors adapted to detect the presence of pressure applied to any one of the plurality of segments, and
control logic for generating a signal corresponding to the segment to which pressure has been applied, the plurality of sensors being operatively connected to the controller.

10. The display device of claim 1, wherein the vertical selection means comprises:
a touch-sensitive activation area embedded within an outer surface of the housing of the display device, the touch-sensitive activation area having defined thereon a plurality of segments designated as keys, and a plurality of sensors adapted to detect the presence of pressure applied to any one of the plurality of segments, and
control logic for generating a signal corresponding to the segment to which pressure has been applied, the plurality of sensors being operatively connected to the controller.

11. The display device of claim 1, wherein the vertical selection means comprises:
a touch-sensitive activation area embedded within an outer surface of the housing of the display device, and
control logic for generating a signal corresponding to a portion of the touch activation area to which pressure has been applied.

12. A display device of claim 1, wherein a first housing is coupled to a first ends and a second housing is coupled to a second end of the display device.

13. A display device comprising:
a housing,
a viewing portion connected to said housing, said viewing portion being extendable from said housing in an extended configuration and retractable with respect to said housing in a closed configuration,
horizontal detection means for detecting a selected horizontal region within said viewing portion, and for generating a first signal responsive to said horizontal detection,
vertical detection means for detecting a selected vertical region within said viewing portion, and for generating a second signal responsive to said vertical detection, and
a controller for receiving said first and second signals and for activating said vertical and horizontal regions responsive to said first and second received signals, wherein said vertical and horizontal regions comprise an activated area of said viewing portion.

14. A method for activating a horizontal and a vertical region of a viewing portion of a mobile device display, the method comprising:
selecting a desired horizontal position on said viewing portion without touching said viewing portion,
detecting the extended horizontal position
generating a first signal responsive to said detected extended horizontal position,
selecting a desired vertical position on said viewing portion of the device without touching said viewing portion,
detecting the desired vertical position,
generating a second signal responsive to said vertical detection, and
activating said vertical and horizontal regions based on said first and second signals.

15. The method of claim 14, wherein the step of selecting a desired horizontal position on said viewing portion without touching said viewing portion further comprises manually extending the viewing portion of the mobile display device to a desired horizontal position.

16. The method of claim 14, wherein the step of detecting the extended horizontal position further comprises the steps of:
measuring the resistance of a variable resistance element attached to a extending mechanism which stores said viewing portion, and
calculating the horizontal input position based on the measured resistance.

17. The method of claim 14, wherein the step of detecting the extended horizontal position further comprises the steps of:
sensing the number of turns of a extending mechanism of the mobile display device, and calculating the horizontal input position based on the number of turns.

18. The method of claim 14, wherein the step of selecting a desired vertical position on said viewing portion of the device without touching said viewing portion, is performed via a plurality of input buttons.

19. The method of claim 14, wherein the step of selecting a desired vertical position on said viewing portion of the device without touching said viewing portion, is performed via a slider control.

20. The method of claim 14, wherein the step of selecting a desired vertical position on said viewing portion of the device without touching said viewing portion, is performed via a non-transparent touch activation area.

21. The method of claim 14, wherein the step of selecting a desired vertical position on said viewing portion of the device without touching said viewing portion, is performed via a transparent touch activation area.
